(19) United States
(12) Patent Application Publication
(10) Pub. No.: US 2004/0244020 A1
(43) Pub. Date: Dec. 2, 2004

(54) Disk recording and reproducing device

(75) Inventors: Masato Yamaguchi, Kanagawa (JP); Nobuhiko Ando, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 10/802,813

(22) Filed: Mar. 18, 2004

(30) Foreign Application Priority Data
Mar. 26, 2003 (JP) 2003-086029
Feb. 16, 2004 (JP) 2004-038391

(51) Int. Cl. G11B 5/09; G11B 19/02

(52) U.S. Cl. 720/606

(57) ABSTRACT

A disk recording and reproducing device keeps a disk in a standby position spaced from the objective lens of an optical pickup to prevent the objective lens from contacting the surface of the disk even when the objective lens is moved within a movable range because the disk recording and reproducing device are subjected to vibrations, shocks, or the like. The disk recording and reproducing device has a slide plate slidable by a drive element through a rack. When the slide plate slides, the disk is pulled in a horizontal direction from a disk ejecting position and thereafter is lowered vertically and positioned in a disk writing/reading position in which information can be written on and read from the disk by an optical pickup. The slide plate has switch triggers, and a switch having contact pins detectable by the switch triggers is mounted on a chassis. While the disk is moving from the disk writing/reading position toward the disk ejecting position, one of the contact pins is operated by the switch trigger of the slide plate, and the disk is held in a disk standby position which is spaced a predetermined distance from the objective lens of the optical pickup.

### BACKGROUND OF THE INVENTION

The present invention relates to a disk recording and reproducing device such as a cartridge-type optical disk or the like, and more particularly to a disk recording and reproducing device which holds a disk in a standby position spaced from the objective lens of an optical pickup when no information is written on or read from the disk, for thereby preventing the objective lens and the disk from contacting each other.

In recent years, the objective lens of an optical pickup tends to have a greater numerical aperture for achieving higher packing densities and higher storage capacities of optical disks. Since the objective lens has its focal length reduced due to the greater numerical aperture thereof, the distance between the objective lens and the disk surface, i.e., the working distance, is reduced. In certain situations, the working distance is smaller than the distance that the objective lens is movable for controlling the focus by absorbing surface displacements of the disk while information is being recorded on and reproduced from the disk. In such a case, it is impossible to prevent the objective lens and the disk from contacting each other by limiting the range in which the objective lens is movable. According to one countermeasure, the process of adjusting the focus of the objective lens may be intensified to prevent the objective lens and the disk from contacting each other when information is written on or read from the disk.

However, when the disk is in a standby mode in which the process of writing information on and reading information from the disk is temporarily interrupted and a driver circuit for focusing the objective lens is not energized, the above process of preventing the objective lens and the disk from contacting each other cannot be performed. In view of this drawback, it has been proposed to move the objective lens within its movable range to a position remotely spaced from the disk when the driver circuit for focusing the objective lens is not energized, and to keep the objective lens fixed under magnetic attractive forces acting between a permanent magnet and a magnetic body (see, for example, patent document 1).

There has also been proposed a process of attracting the objective lens securely to a position retracted from the disk under electromagnetic forces when the driver circuit for focusing the objective lens is not energized (see, for example, patent document 2).

Patent document 1: Japanese patent laid-open No. Hei 7-98875.

Patent document 2: Japanese patent laid-open No. 2002-251758.

The optical pickup is constructed of a number of parts, including a laser beam source, a beam splitter, etc. housed in a small space in its casing. In view of demands for smaller-size and lighter optical pickups, it is not an easy task to include a mechanism for retracting and fixing the objective lens away from the disk within the optical pickup.

### SUMMARY OF THE INVENTION

It is therefore an object of the present invention to provide a disk recording and reproducing device for keeping a disk in a standby position spaced from the objective lens of an optical pickup by a predetermined distance while the disk is moving in a discharging direction from a disk writing/reading position, so that the objective lens can be prevented from contacting the surface of the disk even when the objective lens is moved within a movable range because the disk recording and reproducing device are subjected to vibrations, shocks, or the like.

To achieve the above object, a disk recording and reproducing device according to claim 1 of the present invention has a switch trigger on a slide member which is slidable by a drive element through a rack, and detecting element on a chassis of the disk recording and reproducing apparatus for being electrically detected by the switch trigger, wherein while the disk is moving from a disk writing/reading position toward a disk ejecting, position, the detecting element is operated by the switch trigger of the slide member, and the disk is held in a disk standby position which is spaced a predetermined distance from an objective lens of the optical pickup.

With the above disk recording and reproducing apparatus, since the disk is held in the disk standby position while the disk is moving from the disk writing/reading position toward the disk ejecting position, even when the objective lens is moved in a movable range thereof because the disk recording and reproducing apparatus is subjected to vibrations, shocks, or the like, the objective lens is prevented from contacting the surface of the disk without the need for a conventional fixing means for retracting the optical pickup away from the disk.

Furthermore, the disk is stopped in the standby position when it is pulled upwardly vertically while the disk is moving from the disk writing/reading position toward the disk ejecting position. Therefore, the present invention can easily be reduced to practice without changing or modifying the mechanism of the optical pickup which is of a small-size, precise structure. In addition, the disk recording and reproducing apparatus itself does not have its size increased.

The above and other objects, features, and advantages of the present invention will become apparent from the following description when taken in conjunction with the accompanying drawings which illustrate a preferred embodiment of the present invention by way of example.

### BRIEF DESCRIPTION OF THE DRAWINGS

FIG. 1 is an exploded perspective view of a disk drive as a disk recording and reproducing device according to the present invention and a disk cartridge for use with the disk drive;

FIG. 2 is a side elevational view of the disk drive when it is operated to eject the disk cartridge into a disk ejecting position;

FIG. 3 is a side elevational view of the disk drive when it is operated to bring the disk cartridge into a disk standby position;

FIG. 4 is a side elevational view of the disk drive when it is operated to bring the disk cartridge into a disk writing/reading position;

FIG. 5 is a front elevational view, partly in cross section, showing the distance between the disk surface and the objective lens when the disk cartridge is in the disk ejecting position;

FIG. 6 is a front elevational view, partly in cross section, showing the distance between the disk surface and the objective lens when the disk cartridge is in the disk standby position; and

FIG. 7 is a front elevational view, partly in cross section, showing the distance between the disk surface and the objective lens when the disk cartridge is in the disk writing/reading position.

### DETAILED DESCRIPTION OF THE PREFERRED EMBODIMENT

A disk recording and reproducing device according to a preferred embodiment of the present invention for use with an optical disk housed in a cartridge casing (hereinafter referred to as “disk cartridge”) will be described below.

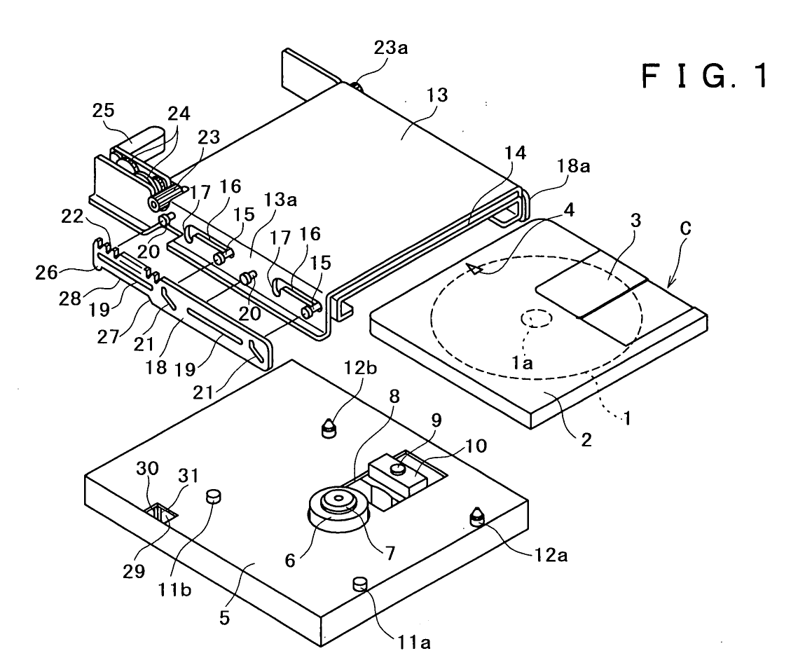

First, a disk cartridge C used as a recording medium will be described below with reference to FIGS. 1 through 4.

As shown in FIGS. 1 through 4, the disk cartridge C has an optical disk (hereinafter referred to as “disk”) 1 rotatably housed in a cartridge casing 2 which includes an upper casing half and a lower casing half that are integrally joined to each other. On one side of the cartridge casing 2, there is mounted a shutter plate 3 that is slidably movable selectively into an open position and a closed position. When the shutter plate 3 is moved into the open position, window holes defined in the upper and lower casing halves in a radial direction of the disk 1 are opened, exposing a radial portion of the disk 1 therethrough. Then, a magnetic head (not shown) biases the disk 1 through the window hole in the upper casing half, for example, of the cartridge casing 2, and an optical pickup applies a laser beam to the exposed surface of the disk 1 through the window hole in the lower casing half. A laser beam reflected from the exposed surface of the disk 1 is detected to write information on and read information from the disk 1. A marker 4 is applied to the cartridge casing 2 to indicate a direction in which to insert the disk cartridge C into the disk recording and reproducing device (hereinafter referred to as the “disk drive”).

The disk drive will be described below with reference to FIG. 1.

As shown in FIG. 1, the disk drive has a chassis 5 serving as a base board thereof and a turntable 6 rotatably mounted on the chassis 5. The turntable 6 can be rotated about its own axis by a spindle motor (not shown) disposed on the reverse side of the chassis 5. The turntable 6 has a chuck unit 7 for holding the inner edge of the disk 1 around a central hole la defined therein when the disk 1 housed in the cartridge casing 2 is loaded into the disk drive.

The disk drive also has an optical pickup 10 mounted in the chassis 5 and having an objective lens 9 disposed in a window 8 defined in the chassis 5 adjacent to the turntable 6. The optical pickup 10 is movable radially across the disk 1 that is clamped on the turntable 6 by the chuck unit 7, i.e., perpendicularly to tracks on the disk 1 that is being rotated by the turntable 6, for writing information on and reading information from the disk 1.

On the chassis 5, there are mounted a pair of front and rear height determining bases 11a, 11b and a pair of front and rear positioning bases 12a, 12b for accurately positioning the disk cartridge C in a reading/writing position in the disk drive.

The disk drive has a housing 13 mounted on the chassis 5 and a holder 14 disposed in the housing 13 for holding the disk cartridge C. Mechanisms for moving the holder 14 with respect to the housing 13 will be described below. These mechanisms include identical left and right mechanisms which move synchronously in phase with each other. Therefore, the parts of only one of these mechanisms will be described below, with the parts of the other mechanism being denoted by identical reference numerals with a suffix “a”.

A pair of front and rear pins 15 projects from a side wall of the holder 14, and extends through respective horizontal guide grooves 16 defined in a side wall 13a of the housing 13, thus supporting the holder 13 on the housing 13. Shorter vertical guide grooves 17 are also defined in the side wall 13a of the housing 13 and joined to respective ends of the horizontal guide grooves 16. The horizontal guide grooves 16 and the shorter vertical guide grooves 17 jointly make up substantially L-shaped guide grooves that are 90° angularly displaced for guiding movement of the holder 13 with respect to the housing 13.

A slide plate 18 is disposed on an outer surface of the side wall 13a of the housing 13. The slide plate 18 has a pair of front and rear horizontal guide holes 19 defined therein. Guide pins 20 projecting from the side wall 13a of the housing 13 movably engage in the respective guide holes 19, allowing the slide plate 18 to move horizontally back and forth over the side wall 13a.

The slide plate 18 also has a pair of front and rear slanted cam slots 21 defined therein adjacent to the guide holes 19, respectively. The pins 15 projecting from the holder 14 through the respective horizontal guide grooves 16 in the housing 13 movably engage in the respective slanted cam slots 21.

The slide plate 18 has a rack 22 formed on a rear upper side edge thereof and held in mesh with a pinion 23 that is supported on one side of the housing 13. The pinion 23 has a shaft extending toward the other side of the housing 13 and supporting a pinion 23a on its distal end. The pinion 23a is held in mesh with a rack (not shown) of another slide plate 18a. The pinion 23 is operatively coupled to the output shaft of a drive motor 25, which includes a DC motor or the like, through a speed reduction gear mechanism 24.

The slide plate 18 has on its lower side a first switch trigger 26 disposed in the form of a tooth on its rear end for pressing contact pins of a detecting switch, to be described later on, and a second switch trigger 27 disposed forwardly of the first switch trigger 26, also for pressing the contact pins of the detecting switch. The slide plate 18 has a recess 28 defined in its lower side between the first switch trigger 26 and the second switch trigger 27.

A detecting switch 29 is mounted in the chassis 5 beneath the slide plate 18 which has the first switch trigger 26 and the second switch trigger 27. The detecting switch 29 has a first contact pin 30 and a second contact pin 31 disposed adjacent to each other and projecting upwardly.

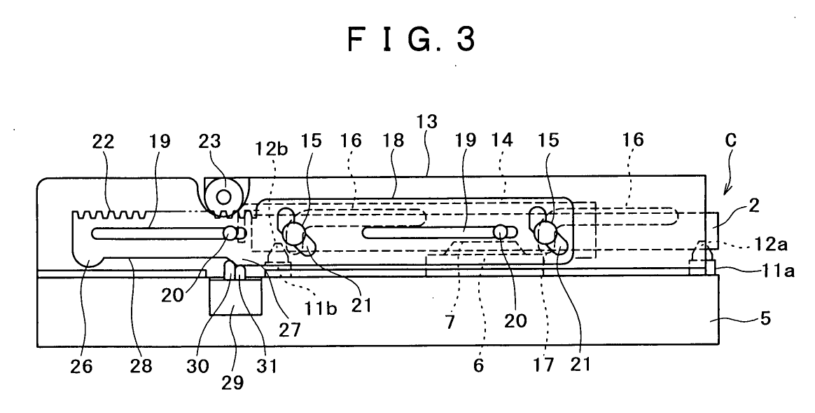

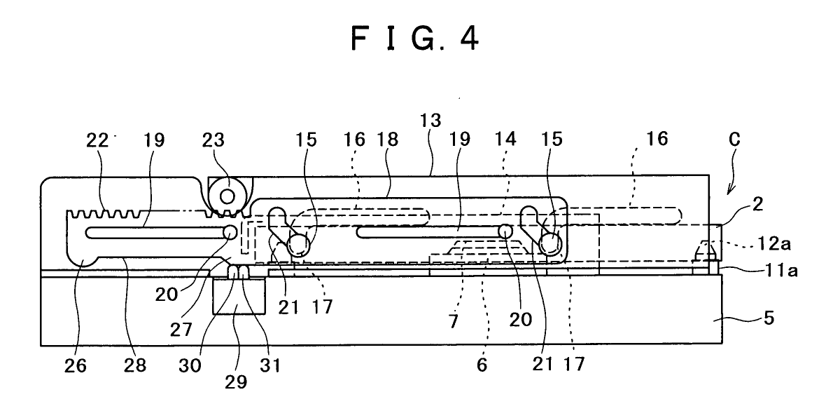

The speed reduction gear mechanism 24 and the drive motor 25 are omitted from illustration in FIGS. 3 and 4.

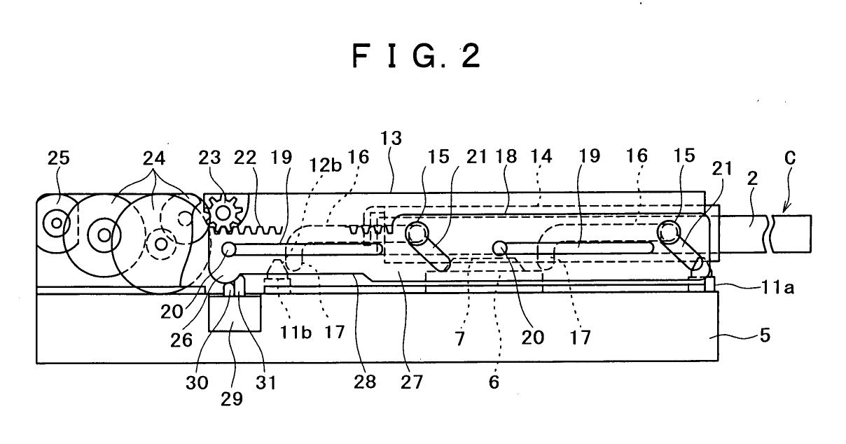

Operation of the disk drive thus constructed will be described below with reference to FIGS. 2 through 4.

FIG. 2 shows in side elevation the disk drive when it is operated to eject the disk cartridge C into a disk ejecting position. At this time, the first contact pin 30 of the detecting switch 29 is turned on by being pressed by the first switch trigger 26 of the slide plate 18, and the second contact pin 31 is turned off by being positioned in the recess 28 in the slide plate 18. The disk cartridge C as it is in the disk ejecting position is detected by such a combination of the turned-on and -off states of the first and second contact pins 30, 31.

When a writing/reading mode for writing information on and reading information from the disc cartridge C is selected from the disk ejecting position, the drive motor 25 is energized to rotate the pinion 23 through a speed reduction gear mechanism 24, causing the rack 22 held in mesh with the pinion 23 to withdraw the slide plate 18 into the disk drive. As the slide plate 18 is withdrawn, the pins 15 on the holder 14 are moved along the respective horizontal guide grooves 16 in the housing 13 to pull in the holder 14 which is holding the disk cartridge C. After the pins 15 have reached the ends of the horizontal guide grooves 16, the slide plate 18 is further pulled in to cause the cam slots 21 to move the pins 15 downwardly along the vertical guide grooves 17. The holder 14 and the disk cartridge C are lowered, then the under surface of the disk cartridge C is positioned on a pair of front and rear height determining bases 11a, 11b and a pair of front and rear positioning bases 12a, 12b which also determine vertical position, and reach a disk writing/reading position shown in FIG. 4.

When the slide plate 18 is pulled from the disk ejecting position, both the first and second contact pins 30, 31 of the detecting switch 29 are turned off by the recess 28. When disk cartridge C reaches the disk writing/reading position, both the first and second contact pins 30, 31 are turned on by being pressed by the second switch trigger 27, thus detecting the disk writing/reading position. In the disk writing/reading position, a focus control circuit for the objective lens 9 of the optical pickup 10 is energized to write information on or read information from the disk 1 in the disk cartridge C.

When a disk standby mode is selected from the disk writing/reading position shown in FIG. 4, the drive motor 25 is reversed to pull back the slide plate 18. The pins 15 on the holder 14 are moved upwardly along the respective vertical guide grooves 17, slightly elevating the holder 14 and the disk cartridge C in a discharging direction into a disk standby position where the holder 14 and the disk cartridge C are stopped. That is, in this movement, the slide plate 18 is pulled back in a direction opposite to the direction in which it is pulled in. At this time, the first contact pin 30 of the detecting switch 29 is displaced from the second switch trigger 27 into the recess 28, and hence is turned off. However, the second contact pin 31 remains turned on by the second switch trigger 27. The disk cartridge C as it is in the disk standby position is detected by such a combination of the turned-off and -on states of the first and second contact pins 30, 31. In the disk standby position, the focus control circuit for the objective lens 9 of the optical pickup 10 is de-energized.

When the writing/reading mode is selected again from the disk standby position, the slide plate 18 is pulled in to lower the holder 14 and the disk cartridge C, thus bringing the disk cartridge C into the disk writing/reading position shown in FIG. 4. When disk cartridge C reaches the disk writing/reading position, both the first and second contact pins 30, 31 are turned on by the second switch trigger 27, thus detecting the disk writing/reading position.

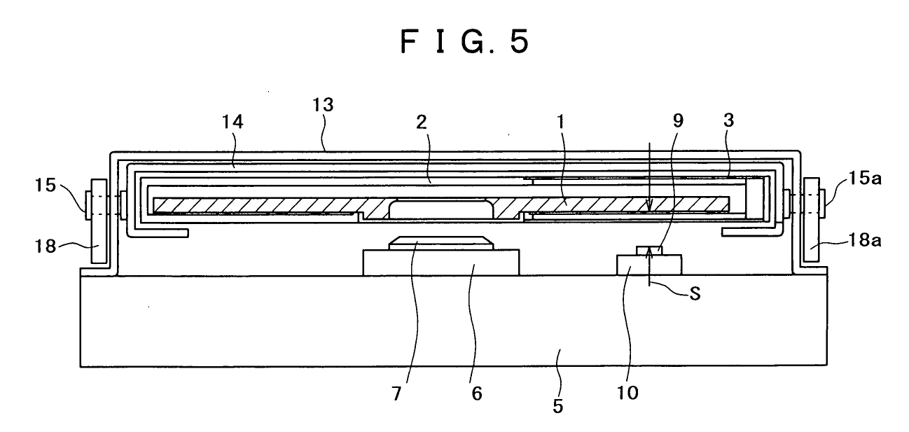

The distances between the surface of the disk 1 and the objective lens 9 of the optical pickup 10 respectively in the disk ejecting position, the disk standby position, and the disk writing/reading position will be described below with reference to FIGS. 5 through 7.

FIG. 5 shows the distance between the surface of the disk 1 and the objective lens 9 when the disk cartridge C is in the disk-ejecting position. In the disk ejecting position, as shown in FIG. 5, the surface of the disk 1 and the objective lens 9 are spaced from each other by a sufficient distance S, and, in addition, the surface of the disk 1 is protected by the shutter plate 3 of the disk cartridge C.

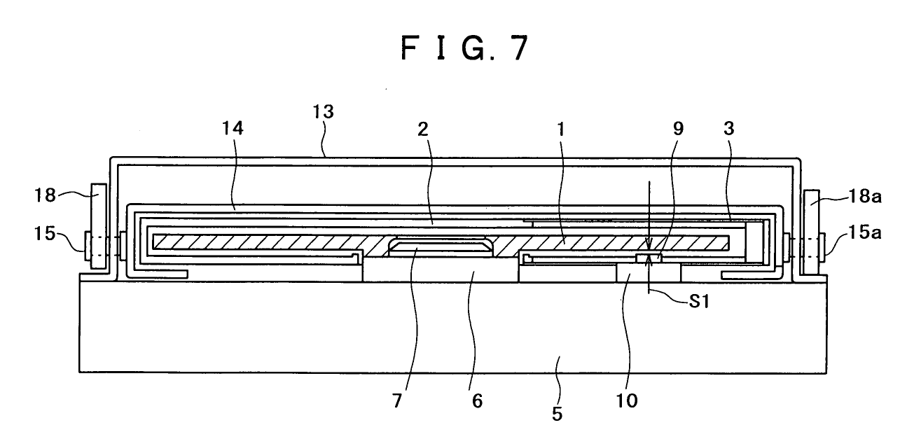

FIG. 7 shows the distance between the surface of the disk 1 and the objective lens 9 when the disk cartridge C is in the disk writing/reading position. In the disk writing/reading position, as shown in FIG. 7, the surface of the disk 1 and the objective lens 9 are spaced from each other by a smallest distance S1 and hence are closest to each other. In the disk writing/reading position, the objective lens 9 is movable a certain distance because its focus is controlled in order to absorb surface displacements of the disk 1.

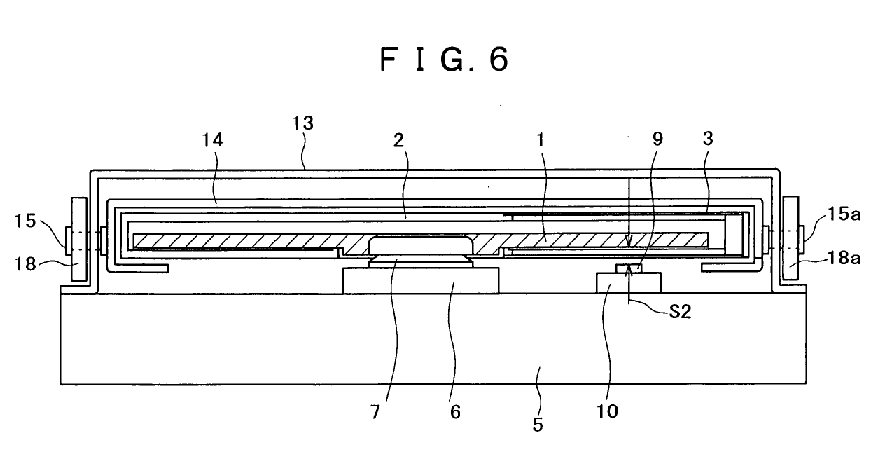

FIG. 6 shows the distance between the surface of the disk 1 and the objective lens 9 when the disk cartridge C is in the disk standby position. In the disk standby position, the focus control circuit for the objective lens 9 of the optical pickup 10 is de-energized, and the surface of the disk 1 and the objective lens 9 are spaced from each other by a distance S2 which is large enough to keep the surface of the disk 1 out of contact with the objective lens 9 even when the objective lens 9 moves in its movable range.

According to the present invention, the disk cartridge C is stopped in the disk standby position to keep a sufficiently large distance between the objective lens 9 and the surface of the disk 1 even though the focus control circuit for the objective lens 9 of the optical pickup 10 is de-energized. The objective lens 9 can thus be prevented from contacting the surface of the disk 1 when subjected to vibrations, shocks, or the like.

The disk drive according to the present invention does not employ a mechanism for retracting the objective lens into a position away from the disk, unlike those disclosed in the patent documents 1, 2. Rather, the disk drive according to the present invention stops the disk cartridge C in the disk standby position on its upward movement while the disk cartridge C is moving from the disk writing/reading position toward the disk ejecting position. Accordingly, the present invention can easily be reduced to practice without modifying the optical pickup. Furthermore, the disk drive is not unduly increased in its entire size.

In the preferred embodiment, the present invention is shown as being applied to a disk drive for a disk cartridge housing an optical disk therein. However, the principles of the present invention are also applicable to other disk drives for disk cartridges housing magneto-optical disks and MDs (mini-disks).

Although a certain preferred embodiment of the present invention has been shown and described in detail, it should be understood that various changes and modifications may be made therein without departing from the scope of the appended claims.

What is claimed is:

1. A disk recording and reproducing device having a slide member which is slidable by drive means through a rack to pull a disk in a horizontal direction from a disk ejecting position and thereafter lower the disk vertically and position the disk in a disk writing/reading position in which information can be written on and read from the disk by an optical pickup,
wherein said slide member has a switch trigger, and said disk recording and reproducing device has detecting means on a chassis thereof for being electrically detected by said switch trigger, and
wherein while the disk is moving from the disk writing/reading position toward the disk ejecting position, said detecting means is operated by the switch trigger of said slide member, and the disk is held in a disk standby position which is spaced a predetermined distance from an objective lens of said optical pickup.

2. The disk recording and reproducing device according to claim 1, wherein in said disk standby position, a surface of said disk is spaced from said objective lens by a distance large enough to prevent said objective lens from contacting the surface of said disk even when said objective lens is moved in a movable range thereof.

3. The disk recording and reproducing device according to claim 1, wherein said disk is stopped in said disk standby position on upward movement thereof while said disk is moving from said disk writing/reading position toward said disk ejecting position.

4. The disk recording and reproducing device according to claim 1, wherein said detecting means detects the disk ejecting position, said disk writing/reading position, and said disk standby position based on a combination of the turning on and off of a pair of switches.

5. The disk recording and reproducing device according to claim 1, wherein said disk comprises a cartridge-type disk.
